(19) United States
(12) Patent Application Publication
(10) Pub. No.: US 2008/0197273 A1
(43) Pub. Date: Aug. 21, 2008

(54) Light Detection Apparatus

(76) Inventor: Paul Andrew Mitchell, Lancaster, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/017,416

(22) Filed: Jan. 22, 2008

Related U.S. Application Data
(60) Provisional application No. 60/886,249, filed on Jan. 23, 2007.

(51) Int. Cl. G02B 6/34

(52) U.S. Cl. 250/227.24

(57) ABSTRACT

A light detection apparatus is described. The apparatus includes a photomultiplier tube having a window for receiving light incident thereon. A photocathode is affixed to an inner surface of the window in a known manner. The apparatus further includes an optical fiber and a means for coupling the optical fiber to the window of said photomultiplier tube so that light can be introduced into the window at an angle that results in total internal reflection of the light. The coupling means may be embodied as a fiber optic terminal connector. Alternatively, the coupling means may include a prism affixed to the outside surface of the window.

### CROSS REFERENCE TO RELATED APPLICATION

This application claims the benefit of U.S. Provisional Application No. 60/886,249, filed Jan. 23, 2007, the entirety of which is incorporated by reference herein.

### BACKGROUND OF THE INVENTION

In the detection of weak light that is transmitted to a photomultiplier-based detector using fiber optic light guides, the photomultiplier tube loses light because of reflection at the input window and also because of transmission through the light sensitive photocathode surface, especially at longer wavelengths (i.e., the red-end of the visible spectrum).

It has been shown that, for a narrow beam (“pencil”) of light that is directed toward the input window of a photomultiplier tube at an angle relative to the normal of the window surface, a large increase in sensitivity can be obtained as a result of total internal reflection that occurs in the photomultiplier's window. A prism is used to adapt the light beam to the window and prevent a large reflection at the first interface. The range of angles is limited. Hitherto, fiber-delivered light was not expected to benefit from this phenomenon because of the large angular spread of such light.

### SUMMARY OF THE INVENTION

In accordance with a first aspect of the present invention there is provided an apparatus for the detection of a light signal. The apparatus according to this aspect of the invention includes a photomultiplier tube having a window for receiving light incident thereon. A photocathode is affixed to an inner surface of the window in a known manner. The apparatus further includes an optical fiber and a means for coupling the optical fiber to the window of said photomultiplier tube so that light can be introduced into the window at an angle that results in total internal reflection of the light. The coupling means may be embodied as a fiber optic terminal connector. Alternatively, the coupling means may include a prism affixed to the outside surface of the window.

In accordance with another aspect of the present invention there is provided an apparatus for the detection of a light signal. The apparatus according to this aspect of the invention includes a photomultiplier tube having a window for receiving light incident thereon and a photocathode affixed to an inner surface of the window. An opaque housing surrounds the photomultiplier tube. The housing has an opening therein that is in alignment with the window. The apparatus also includes an optical fiber and a connector attached to the housing at the opening for coupling the optical fiber to the window of the photomultiplier tube.

### BRIEF DESCRIPTION OF THE DRAWINGS

The foregoing summary as well as the following detailed description will be better understood when read with reference to the drawings, wherein:

FIG. 1 is a perspective view of a light detection apparatus according to the present invention;

FIG. 2 is a schematic view in partial section of the light detection apparatus shown in FIG. 1;

FIG. 3 is a schematic view of a window of a photomultiplier tube used in the light detection apparatus shown in FIG. 1, in which an optical fiber light guide is coupled to the edge of the window;

FIG. 4 is a chart of graphs of the cathode spectral response for three light detectors according to the present invention and a comparative light detector;

FIG. 5 is a schematic view of a window of a photomultiplier tube used in the light detection apparatus shown in FIG. 1, in which an optical fiber light guide is coupled to the window with a prism; and

FIG. 6 is a schematic circuit diagram of a photomultiplier tube used in the light detection apparatus according to this invention.

### DESCRIPTION OF THE INVENTION

I have determined that it is possible to obtain a significant increase in photomultiplier sensitivity in the case of fiber-delivered light using the total internal reflection phenomenon. This development makes the photomultiplier a very effective detector for applications such as laser induced fluoresence or cytometry where the light signal is transmitted to the detector by fiber optic means.

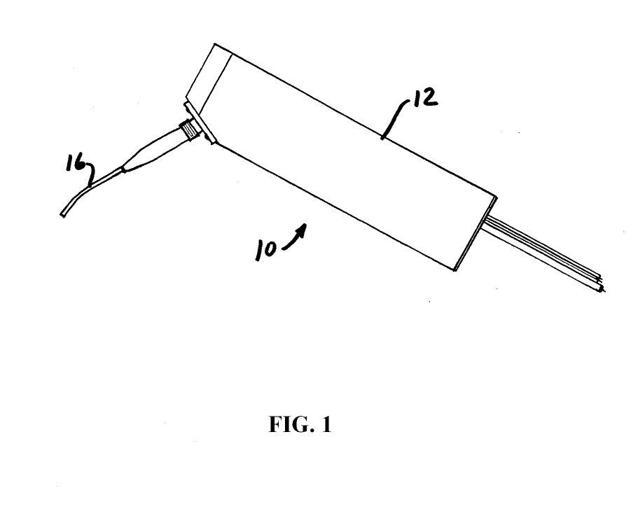

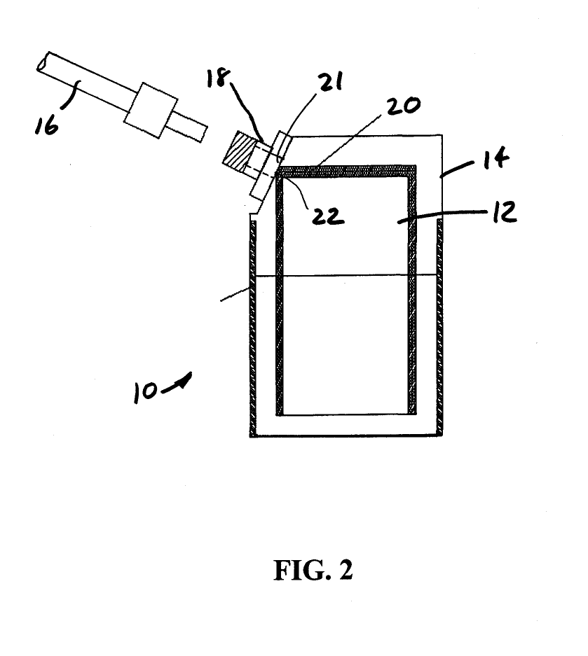

Referring now to the drawings, and in particular to FIGS. 1 and 2, there is shown a light detection apparatus 10 for the detection of light according to this invention. The apparatus 10 includes a photomultiplier tube 12 and an optical fiber 16 that is seamlessly connected to the input window of the photomulitplier tube 12. The photomultiplier tube 12 has a window 20 at one thereof. The window is preferably plano-plano (i.e., planar inner and outer surfaces) in construction to allow the light to maintain a constant angle of internal reflection as the light passes transversely across the window. The photomultiplier 12 is surrounded by an enclosure 14 that is opaque to light. The enclosure 14 has an opening 21 that is aligned with a beveled edge 22 of the window 20. The optical fiber 16 is coupled to the photomultiplier 12 with a connector 18 that is preferably an SMA connector. The connector 18 is attached to the enclosure 14 over the opening 21 so that an end of the optical fiber 16 is in close proximity to the beveled edge 22.

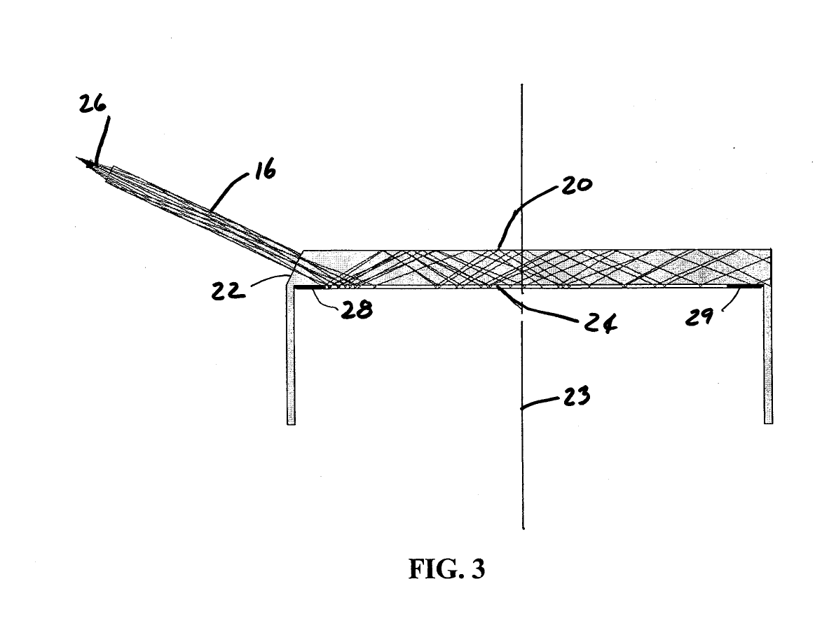

In order to achieve sufficient internal reflection of the light in the photomultiplier window, the window should be relatively thin, but should be thick enough to permit the light from the fiber to enter in an unobstructed manner. The angle of the fiber relative to the plane of the window is selected to maximize the response of the photocathode. The preferred range of angles is in the range of about 42 degrees to about 85 degrees relative to an axis 23 that is normal to the planar surface of the window 20, as shown in FIG. 3.

It is also preferred that the end of the optical fiber be positioned as closely as possible to the photocathode, thereby making a substantially continuous light path through the window and toward the photocathode. This approach minimizes the divergence of the light bundle and maximizes the interaction of the light with the photocathode.

The edge of the photomultiplier tube window would normally not be considered as an entrance point for the light because of the poor collection of the electrons created there. The efficiency of the design would be lost because of failure of the electrons so close to the edge to contribute to the response signal. However, the device according to this invention provides a way to prevent such loss by use of a mirrored surface 28 to block light at the very edge from being absorbed uselessly by the photocathode 24. Instead, the light is tipped away by the reflector 28 so that the light can be reflected back to the photocathode 24 at a point further from the edge of the window 20.

For glancing rays or for light of such long wavelength that absorption by the photocathode is poor, a second mirrored surface 29 is provided at the far end of the window 20 from the point of entry. This second reflector 29 is formed and disposed for returning such light to permit further internal reflection back toward the point of entry, thereby providing a second pass along the photocathode 24.

The thickness of the photocathode itself, and/or an adaptive dielectric layer, is chosen preferably to optimize the performance of the apparatus. In the case of total internal reflection, light loss due to transmission through the photocathode or reflection at the glass/photocathode interface is nearly absent. The cathode thickness is preferably thin enough to enhance electron escape. Additionally, the photocathode 24 can be thinner at the beginning of the interaction region, where blue light is most effectively detected, and thicker further across the input window, where red light is detected.

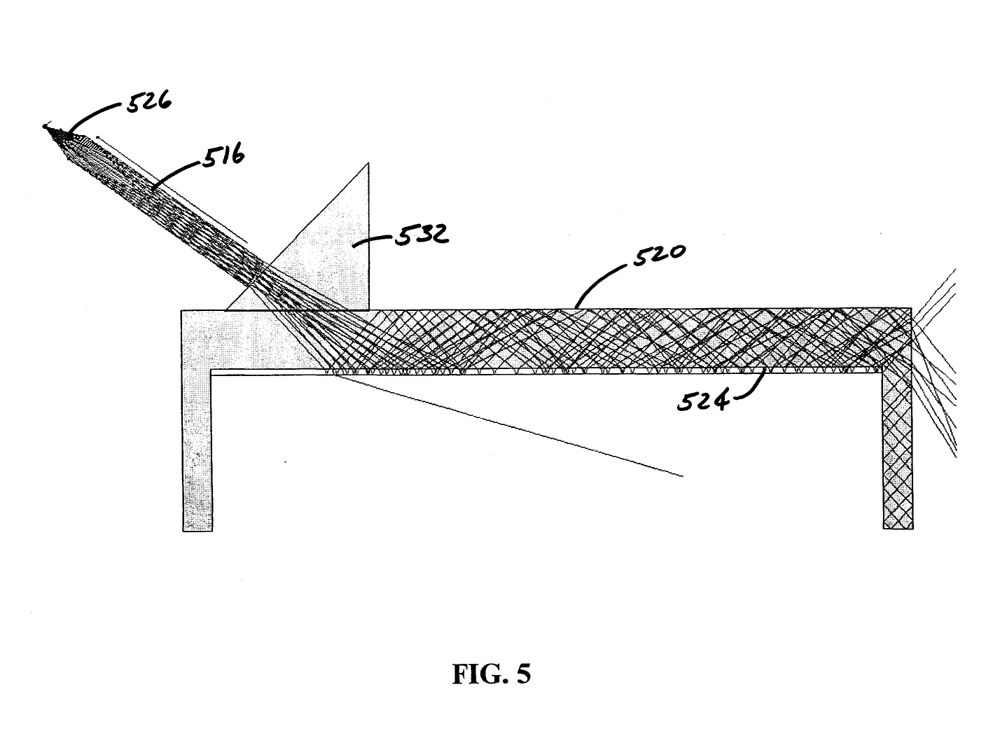

In an alternative arrangement as shown in FIG. 5, a prism 532 is affixed to the top surface of the photomultiplier window 520. The prism 532 is positioned in a peripheral region of the window surface and disposed in the light path between the optical fiber 516 and the photomultiplier window 520. This arrangement is preferred for use where the edge of the photomultiplier input window is not accessible. Such a case may occur with a tube having a metal flange around the input window. In the arrangement shown in FIG. 5, the light path is not seamless. However, light loss can be minimized by keeping the distance from the fiber tip to the photocathode surface to a minimum. Additionally, the refractive index of the prism can be selected to minimize the angular spread of the light 526 as it emerges from the optical fiber 516.

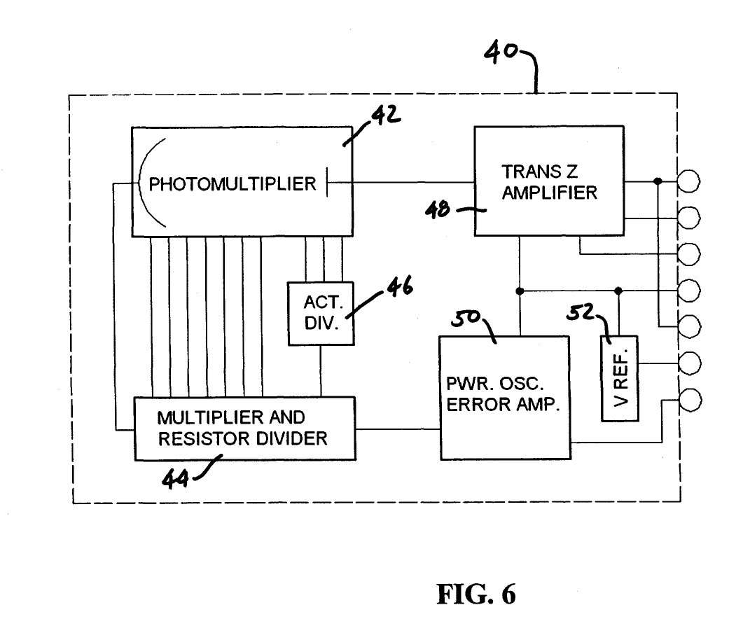

Referring now to FIG. 6, there is shown a preferred circuit 40 for the photomultiplier used in the light detection apparatus according to the present invention. The circuit 40 includes a high voltage supply module that utilizes a hybrid voltage divider network in which sections of the dynode chain of the photomultiplier 42 that require higher current levels are separated from those that have very low current requirements. Such a voltage supply network is described in U.S. Pat. No. 7,005,625, the entirety of which is incorporated by reference. The voltage supply network includes a resistor-based voltage divider circuit 44 for controlling the dynode voltage of the upper dynodes in the photomultiplier tube 42. An active transistor circuit 46 is provided for the lower stage dynodes to provide voltage stabilization without incurring extra current demand.

The signal from the photomultiplier anode is preferably processed with a transimpedance amplifier 48. The gain of the photomultiplier-amplifier combination can be selected to permit the detection of single photoelectrons. However, the circuit 40 can be configured with other gain settings depending on the particular application in which the light detection apparatus will be used. The circuit 40 preferably also includes a in internal reference voltage supply 52 for use in setting the high voltage applied to the photomultiplier cathode, dynodes, and anode.

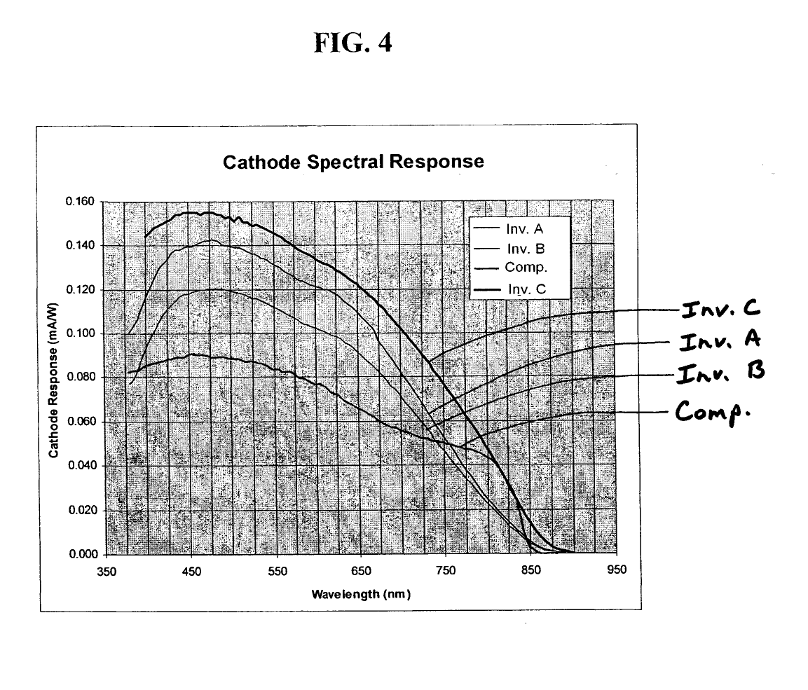

The benefit provided by the light detection apparatus according to this invention is clearly shown by reference to FIG. 4 which is a chart of graphs of photocathode response of a conventional photomultiplier tube and three light detection apparatuses according to the present invention. The graphs illustrate the responses of the device photocathodes to light over a wavelength range of 400 to 850 nm. The responses of light detectors having a prism launch arrangement as shown in FIG. 5 are designated “Inv. A” and “Inv. B”. The response curve of a known, high performance reflection mode photocathode is designated “Comp.” The graph for a light detector having an edge launch arrangement (Inv. C) according to the present invention is also shown. The graphs of the responses for the prism launch examples (Inv. A and Inv. B) are clearly better than the response of the known reflection mode photomultiplier tube up to about 750 nm. The response for the edge-launch example (Inv. C) is significantly better than the response of all the other examples, even at the longer wavelengths.

It will be recognized by those skilled in the art that changes or modifications may be made to the above-described embodiments without departing from the broad inventive concepts of the invention. It is understood, therefore, that the invention is not limited to the particular embodiments which are described, but is intended to cover all modifications and changes within the scope and spirit of the invention as described above and set forth in the appended claims.

What is claimed is:

1. Apparatus for the detection of a light signal comprising:
a photomultiplier tube having a window for receiving light incident thereon and a photocathode affixed to an inner surface of the window;
an optical fiber; and
means for coupling said optical fiber to the window of said photomultiplier tube, such that light can be introduced into the window at an angle that results in total internal reflection of the light within said window.

2. Apparatus as claimed in claim 1 wherein the window of the photomultiplier tube has a bevel formed in an edge thereof and the coupling means comprises a fiber optic terminal connector affixed to the window at the bevel.

3. Apparatus as claimed in claim 2 wherein the window comprises a reflective surface affixed along a portion of the inner surface of the window adjacent to a location where the optical fiber is coupled to the window.

4. Apparatus as claimed in claim 3 wherein the window comprises a second reflective surface at a location distal from the fiber optic terminal connector.

5. Apparatus as claimed in any one of claims 1 to 4 wherein the optical fiber is coupled to the window at an angle in the range of about 42° to about 85° relative to an axis that is perpendicular to the window.

6. Apparatus as claimed in claim 1 wherein the window of the photomultiplier tube has a planar exterior surface and the coupling means comprises a prism affixed to said planar exterior surface.

7. Apparatus as claimed in claim 6 wherein said window has a peripheral region and said prism is positioned in said peripheral region.

8. Apparatus as claimed in claim 6 or claim 7 wherein the optical fiber is coupled to the prism such that light transmitted through said optical fiber enters said window at an angle in the range of about 42° to about 85° relative to an axis that is perpendicular to the window.

9. Apparatus for the detection of a light signal comprising:
a photomultiplier tube having a window for receiving light incident thereon and a photocathode affixed to an inner surface of the window;
a housing surrounding said photomultiplier tube, said housing having an opening therein that is in alignment with the window;
an optical fiber; and
a connector attached to said housing at the opening for coupling said optical fiber to the window of said photomultiplier tube.

10. Apparatus as claimed in claim 9 wherein the window of the photomultiplier tube has a bevel formed in an edge thereof and said connector comprises a fiber optic terminal connector affixed to the window at the bevel.

11. Apparatus as claimed in claim 10 wherein the window comprises a reflective surface affixed along a portion of the inner surface of the window adjacent to a location where the optical fiber is coupled to the window.

12. Apparatus as claimed in claim 11 wherein the window comprises a second reflective surface at a location distal from the fiber optic terminal connector.

13. Apparatus as claimed in any one of claims 9 to 12 wherein the optical fiber is coupled to the window at an angle in the range of about 42° to about 85° relative to an axis that is perpendicular to the window.

14. Apparatus as claimed in claim 9 wherein the window of the photomultiplier tube has a planar exterior surface and said apparatus comprises a prism affixed to said planar exterior surface.

15. Apparatus as claimed in claim 14 wherein said window has a peripheral region and said prism is positioned in said peripheral region.

16. Apparatus as claimed in claim 15 wherein the opening is aligned with a receiving surface of said prism.

17. Apparatus as claimed in any one of claims 14 to 16 wherein the optical fiber is coupled to the prism such that light transmitted through said optical fiber enters said window at an angle in the range of about 42° to about 85° relative to an axis that is perpendicular to the window.

18. Apparatus as claimed in claim 9 wherein the housing is formed of a material that is opaque to light incident thereon.

19. A method of detecting light with a photomultiplier tube comprising the steps of:
providing a photomultiplier tube having a window and a photocathode formed on an inner surface of said window;
coupling an optical fiber to said window such that light can be introduced into the window at an angle that results in total internal reflection of the light within said window;
energizing said photomultiplier tube; and
introducing light into the window of said photomultiplier tube through said optical fiber.

20. A method of making a light detection apparatus comprising the steps of:
providing a photomultiplier tube having a window; and
coupling an optical fiber to said window such that light can be introduced into the window at an angle that results in total internal reflection of the light within said window.

21. The method as claimed in claim 20 comprising the step of surrounding the photomultiplier tube in an enclosure that is opaque to light.

22. The method as claimed in claim 20 comprising the step of providing an opening in said enclosure to permit passage of the optical fiber.

23. The method as set forth in claim 20 comprising the step of forming the window with a planar outer surface and a planar inner surface.
